(19) United States
(12) Patent Application Publication
(10) Pub. No.: US 2026/0292479 A1
(43) Pub. Date: Sep. 24, 2026

(54) ARTIFICIAL INTELLIGENCE/MACHINE LEARNING SIDELINK OPERATION

(71) Applicant: QUALCOMM Incorporated, San Diego, CA (US)

(72) Inventors: Sourjya DUTTA, Jersey City, NJ (US); Kapil GULATI, Belle Mead, NJ (US); Hong CHENG, Basking Ridge, NJ (US); Qing LI, Princeton Junction, NJ (US); Gabi SARKIS, San Diego, CA (US); Tien Viet NGUYEN, Bridgewater, NJ (US); Shijun WU, San Diego, CA (US)

(21) Appl. No.: 19/087,143

(22) Filed: Mar. 21, 2025

(51) Int. Cl. H04W 8/24; H04B 17/318; H04L 41/16; H04W 92/18

(52) U.S. Cl. CPC H04W 8/24; H04B 17/328; H04L 41/16; H04W 92/18

(57) ABSTRACT

Various aspects of the present disclosure generally relate to wireless communication. In some aspects, a first user equipment (UE) may select, in accordance with an artificial intelligence/machine learning model, a sidelink parameter value for sidelink communication with a second UE. The sidelink parameter value is selected from a range of candidate parameter values associated with multi-radio access technology co-channel coexistence or a synchronization reference offset. The UE may update the range of candidate parameter values in accordance with one or more measurements. The UE may transmit, in accordance with the selected sidelink parameter value, a communication over the wireless channel shared by the first RAT and the one or more second RATs. Numerous other aspects are described.

### FIELD OF THE DISCLOSURE

Aspects of the present disclosure generally relate to wireless communication and specifically relate to techniques, apparatuses, and methods associated with sidelink operation in accordance with artificial intelligence/machine learning.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

Some wireless networks permit sidelink communication. Sidelink communication is a wireless communication link established directly between wireless devices (e.g., user equipments (UEs)) without routing the communication through a network node, such as a gNodeB, which may reduce latency and improve reliability, particularly when devices are outside a coverage area of a network or when network infrastructure is overloaded. Additionally, sidelink may offload traffic from the core network, which can improve resource utilization and efficiency.

### SUMMARY

Some aspects described herein relate to a first user equipment (UE). The first UE may include a processing system. The processing system may include one or more processors and one or more code-storing memories coupled with the one or more processors. The processing system may be configured to cause the first UE to select, in accordance with an

AI/ML model, a sidelink parameter value for sidelink communication with a second UE using a first radio access technology (RAT) over a wireless channel shared by the first RAT and one or more second RATs, where the sidelink parameter value is selected from a range of candidate parameter values. The processing system may be configured to cause the first UE to update the range of candidate parameter values in accordance with one or more measurements. The processing system may be configured to cause the first UE to transmit, in accordance with the selected sidelink parameter value, a communication over the wireless channel shared by the first RAT and the one or more second RATs.

Some aspects described herein relate to a first UE. The first UE may include a processing system. The processing system may include one or more processors and one or more code-storing memories coupled with the one or more processors. The processing system may be configured to cause the first UE to select, in accordance with an AI/ML model, a sidelink parameter value for sidelink communication with a second UE without a synchronization source, where the sidelink parameter value is selected from a range of candidate parameter values and is associated with a synchronization reference offset. The processing system may be configured to cause the first UE to update the range of candidate parameter values in accordance with one or more measurements.

Some aspects described herein relate to a method of wireless communication performed by a first UE. The method may include selecting, in accordance with an AI/ML model, a sidelink parameter value for sidelink communication with a second UE using a first RAT over a wireless channel shared by the first RAT and one or more second RATs, where the sidelink parameter value is selected from a range of candidate parameter values. The method may include updating the range of candidate parameter values in accordance with one or more measurements. The method may include transmitting, in accordance with the selected sidelink parameter value, a communication over the wireless channel shared by the first RAT and the one or more second RATs.

Some aspects described herein relate to a method of wireless communication performed by a first UE. The method may include selecting, in accordance with an AI/ML model, a sidelink parameter value for sidelink communication with a second UE without a synchronization source, where the sidelink parameter value is selected from a range of candidate parameter values and is associated with a synchronization reference offset. The method may include updating the range of candidate parameter values in accordance with one or more measurements.

Some aspects described herein relate to a non-transitory computer-readable medium that stores a set of instructions for wireless communication by a first UE. The set of instructions, when executed by one or more processors of the first UE, may cause the first UE to select, in accordance with an AI/ML model, a sidelink parameter value for sidelink communication with a second UE using a first RAT over a wireless channel shared by the first RAT and one or more second RATs, where the sidelink parameter value is selected from a range of candidate parameter values. The set of instructions, when executed by one or more processors of the first UE, may cause the first UE to update the range of candidate parameter values in accordance with one or more measurements.

Some aspects described herein relate to a non-transitory computer-readable medium that stores a set of instructions for wireless communication by a one or more instructions that, when executed by one or more processors of a UE. The set of instructions, when executed by one or more processors of the one or more instructions that, when executed by one or more processors of a UE, may cause the one or more instructions that, when executed by one or more processors of a UE to select, in accordance with an AI/ML model, a sidelink parameter value for sidelink communication with a second UE without a synchronization source, where the sidelink parameter value is selected from a range of candidate parameter values and is associated with a synchronization reference offset. The set of instructions, when executed by one or more processors of the one or more instructions that, when executed by one or more processors of a UE, may cause the one or more instructions that, when executed by one or more processors of a UE to update the range of candidate parameter values in accordance with one or more measurements.

Some aspects described herein relate to an apparatus for wireless communication. The apparatus may include means for selecting, in accordance with an AI/ML model, a sidelink parameter value for sidelink communication with a second UE using a first RAT over a wireless channel shared by the first RAT and one or more second RATs, where the sidelink parameter value is selected from a range of candidate parameter values. The apparatus may include means for updating the range of candidate parameter values in accordance with one or more measurements.

Some aspects described herein relate to an apparatus for wireless communication. The apparatus may include means for selecting, in accordance with an AI/ML model, a sidelink parameter value for sidelink communication with a second UE without a synchronization source, where the sidelink parameter value is selected from a range of candidate parameter values and is associated with a synchronization reference offset. The apparatus may include means for updating the range of candidate parameter values in accordance with one or more measurements.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example disaggregated network node architecture.

FIG. 3 is a diagram illustrating an example architecture of a functional framework for radio access network intelligence enabled by data collection.

FIG. 4 is a diagram illustrating an example associated with using an artificial intelligence/machine learning model to update one or more sidelink parameters in an out-of-coverage scenario.

FIGS. 5 and 6 are diagrams illustrating example processes performed, for example, at a user equipment (UE) or an apparatus of a UE.

FIG. 7 is a diagram of an example apparatus for wireless communication.

### DETAILED DESCRIPTION

Multi-radio access technology (RAT) co-channel coexistence allows multiple RATs to operate concurrently on a common frequency channel. Facilitating multi-RAT co-channel coexistence may include managing radio frequency resources such that each RAT may perform wireless communication while mitigating interference between different RATs. Different RATs may have different frame structures (e.g., orthogonal frequency division multiplexing (OFDM) with different numerologies) or modulation schemes (e.g., OFDM for network communications and non-OFDM for sidelink communications). Parameters for multi-RAT co-channel coexistence may be configured statically through time division multiplexing (TDM)-based resource portioning or dynamically through resource selection based on reservation information.

Sidelink communication allows user equipments (UEs) to communicate directly with one another without routing the communication through a network node. Sidelink communication can provide several benefits including reduced latency, improved network efficiency, improved network reliability, or a combination thereof, among other examples. One use case for sidelink communication is to facilitate vehicle-to-vehicle (V2V), vehicle-to-infrastructure (V2I), or vehicle-to-everything (V2X) communication, particularly in areas where network coverage may be limited. Parameters for sidelink communication, including parameters for sidelink co-channel coexistence, may be configured by the network or through firmware updates. The UE may use the previously configured parameters for sidelink communication when the UE is out of a network coverage area.

Being out of the network coverage area may also or alternatively affect synchronization for sidelink communications. UEs may be paired and synchronized with a global navigation satellite system (GNSS) receiver, and the synchronization between the UEs and the GNSS may be used for sidelink communications. Additionally, UEs engaging in sidelink communication may use a synchronization signal block (SSB) as part of a sidelink synchronization procedure, particularly if the GNSS is not available or if a connection to the GNSS is unreliable. During the sidelink synchronization procedure, the UE may switch from one synchronization source (e.g., synchronizing with the GNSS) to another synchronization source (e.g., using the SSB). The UE may be configured by a network node or via firmware with an offset for switching synchronization sources. If the offset is set too low, the UE may continuously switch between synchronization sources, resulting in what may be referred to as a “ping-pong effect.” While the ping-pong effect can be avoided with a larger offset, applying a larger offset may introduce greater delay. Additionally, a default offset may be set for a particular geographic region, and a UE may be configured to apply the default offset when in the geographic region. The default offset, however, may not be sufficient for different reference signal received power (RSRP) values of different synchronization references or when an RSRP measurement changes over time.

For out-of-coverage scenarios involving sidelink multi-RAT co-channel coexistence and synchronization reference selection, among other examples, relying on the default parameters can allow the UE to participate in sidelink communications. As discussed above, however, the default parameters may result in degraded network performance (e.g., increased delay or greater interference, among other examples).

Various aspects relate generally to sidelink communication in out-of-coverage scenarios. Some aspects more specifically relate to setting one or more parameters associated with sidelink multi-RAT co-channel coexistence or a sidelink synchronization reference. In some aspects, for an out-of-coverage scenario, a UE may be configured to use artificial intelligence/machine learning (AI/ML) to select one or more parameters associated with sidelink multi-RAT co-channel coexistence or sidelink synchronization references.

Particular aspects of the subject matter described in this disclosure can be implemented to realize one or more of the following potential advantages. In some examples, the described techniques can be used to select parameters associated with sidelink multi-RAT co-channel coexistence, sidelink synchronization references, among other examples. For example, in an out-of-coverage scenario, using one or more AI/ML models may allow the UE to apply parameters that provide better performance (e.g., reduced delay or reduced interference, among other examples) than default parameters.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

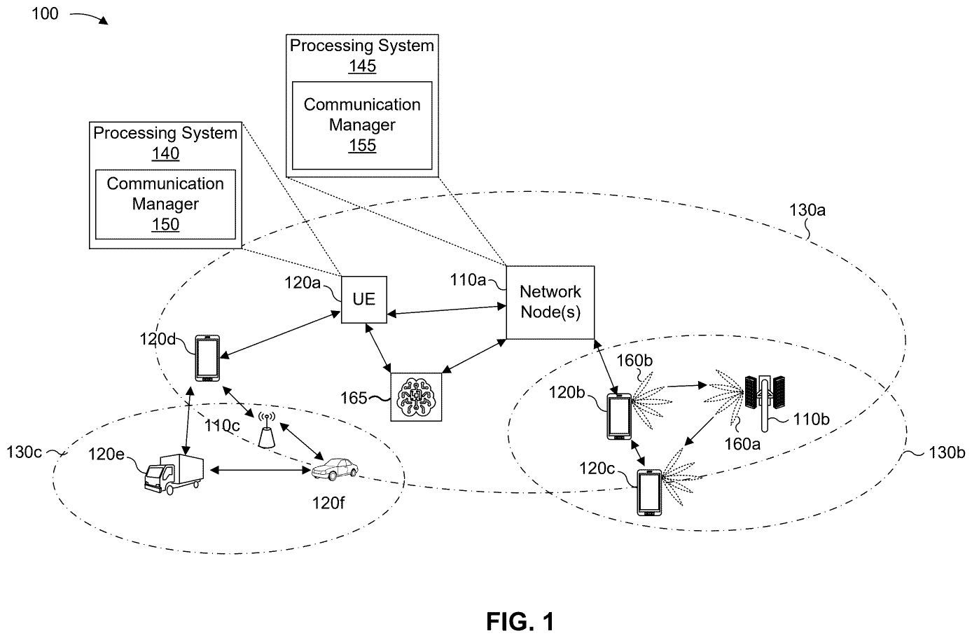

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, a UE 120c, and a UE 120d (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-RSRP parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-OFDM (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the

AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some examples, two or more UEs 120 (for example, shown as UE 120a and UE 120d or UE 120e and UE 120f) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an uplink communication to a network node 110, which then transmits the data to the UE 120e in a downlink communication. In various examples, the UEs 120 may transmit and receive sidelink communications using peer-to-peer (P2P) communication protocols, device-to-device (D2D) communication protocols, V2X communication protocols (which may include V2V protocols, V2I protocols, or vehicle-to-pedestrian (V2P) protocols), or mesh network communication protocols. In some deployments and configurations, a network node 110 may schedule or allocate resources for sidelink communications between UEs 120 in the wireless communication network 100. For example, the cell 130c may include a V2X network supported by the network node 110c. In some examples, the network node 110c may be a roadside unit or other device deployed in the V2X network. In some other deployments and configurations, a UE 120 (instead of a network node 110) may perform, or collaborate or negotiate with one or more other UEs to perform, scheduling operations, resource selection operations, or other operations for sidelink communications. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), or a physical sidelink feedback channel (PSFCH).

In some aspects, the UE 120 (e.g., a first UE) may include a communication manager 150. As described in more detail elsewhere herein, the communication manager 150 may select, in accordance with an AI/ML model, a sidelink parameter value for sidelink communication with a second UE using a first RAT over a wireless channel shared by the first RAT and one or more second RATs. The sidelink parameter value may be selected from a range of candidate parameter values. The communication manager 150 may update the range of candidate parameter values in accordance with one or more measurements and transmit, in accordance with the selected sidelink parameter value, a communication over the wireless channel shared by the first RAT and the one or more second RATs. Additionally, or alternatively, the communication manager 150 may perform one or more other operations described herein. For example, in some aspects, the communication manager 150 may select, in accordance with an AI/ML model, a sidelink parameter value for sidelink communication with a second UE without a synchronization source. The sidelink parameter value may be selected from a range of candidate parameter values and may be associated with a synchronization reference offset. The communication manager 150 may update the range of candidate parameter values in accordance with one or more measurements. Additionally, or alternatively, the communication manager 150 may perform one or more other operations described herein.

In some aspects, the network node 110 may include a communication manager 150. As described in more detail elsewhere herein, the communication manager 155 may transmit, to the UE 120, a configuration or parameters associated with multi-RAT co-channel coexistence in an out-of-coverage scenario or synchronization in the out-of-coverage scenario. Additionally, or alternatively, the communication manager 150 may perform one or more other operations described herein Additionally, or alternatively, the communication manager 150 may perform one or more other operations described herein.

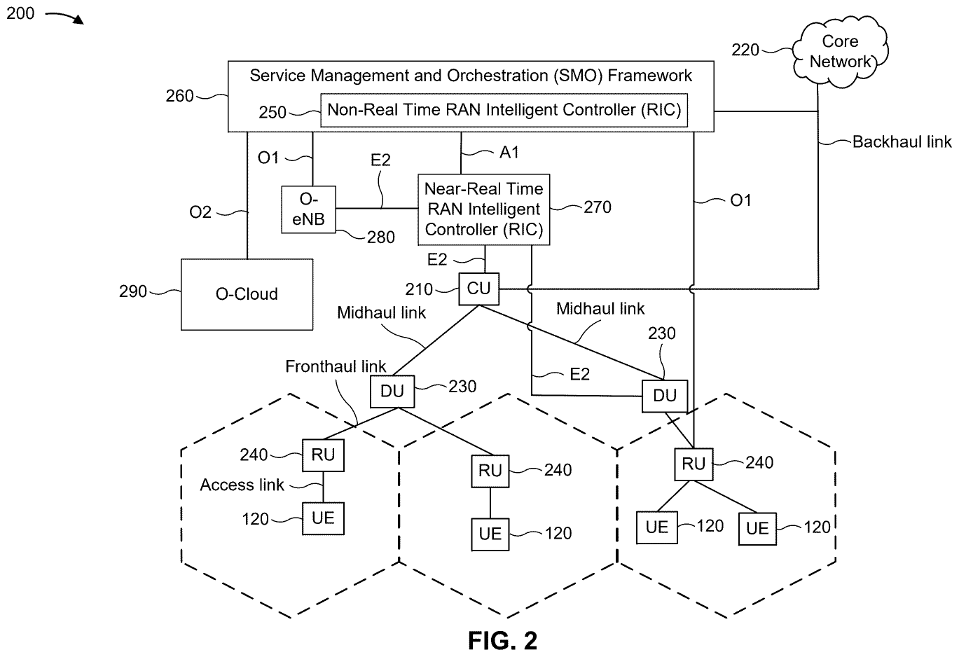

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

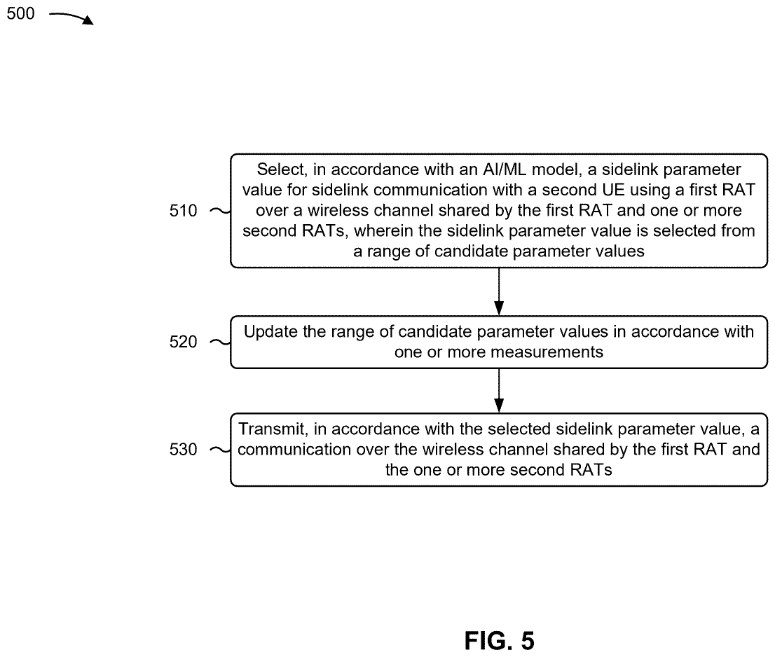

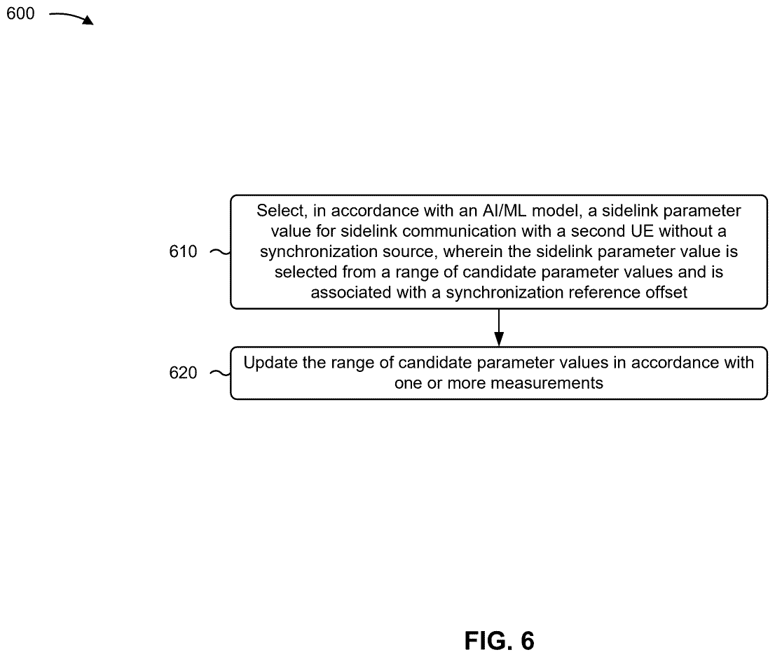

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with using an AI/ML model to select one or more parameters associated with sidelink communication, as described in more detail elsewhere herein. For example, the processing system 145 of the network node 110, the processing system 140 of the UE 120, the CU 210, the DU 230, or the RU 240 may perform or direct operations of, for example, process 500 of FIG. 5, process 600 of FIG. 6, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 500 of FIG. 5, process 600 of FIG. 6, or other processes as described herein. In some examples, executing instructions may include running the instructions, converting the instructions, compiling the instructions, or interpreting the instructions, among other examples.

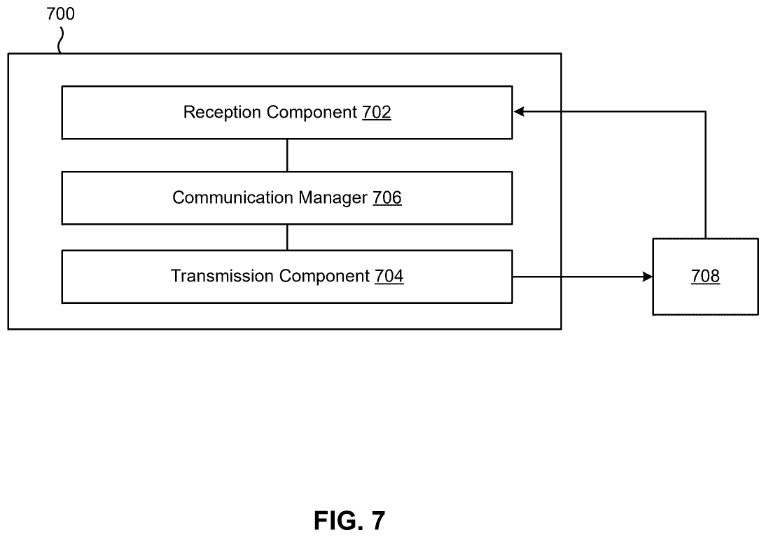

In some aspects, the UE 120 (e.g., a first UE) includes means for selecting, in accordance with an AI/ML model, a sidelink parameter value for sidelink communication with a second UE using a first RAT over a wireless channel shared by the first RAT and one or more second RATs. The sidelink parameter value may be selected from a range of candidate parameter values. The UE 120 may further include means for updating the range of candidate parameter values in accordance with one or more measurements, means for transmitting, in accordance with the selected sidelink parameter value, a communication over the wireless channel shared by the first RAT and the one or more second RATs, or a combination thereof, among other examples. Alternatively or additionally, in some aspects, the UE 120 (e.g., a first UE) includes means for selecting, in accordance with an AI/ML model, a sidelink parameter value for sidelink communication with a second UE without a synchronization source. The sidelink parameter value may be selected from a range of candidate parameter values and may be associated with a synchronization reference offset. The UE 120 may further includes means for updating the range of candidate parameter values in accordance with one or more measurements. The means for the UE 120 to perform operations described herein may include, for example, one or more of communication manager 150, processing system 140, a radio, one or more RF chains, one or more transceivers, one or more antennas, one or more modems, a reception component (for example, reception component 702 depicted and described in connection with FIG. 7), or a transmission component (for example, transmission component 704 depicted and described in connection with FIG. 7), among other examples.

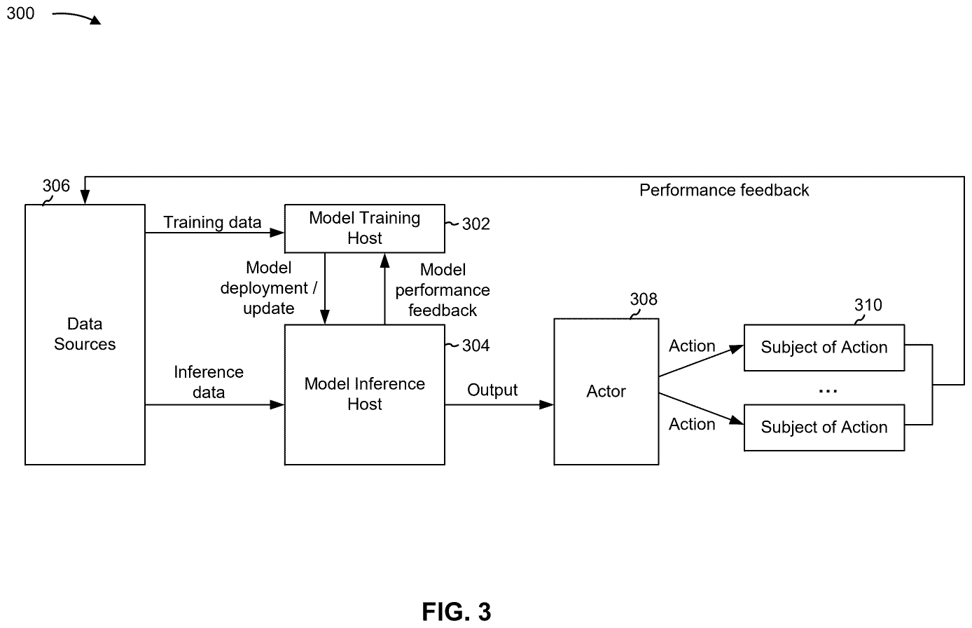

FIG. 3 is a diagram illustrating an example architecture 300 of a functional framework for radio access network (RAN) intelligence enabled by data collection. In some scenarios, the functional framework for RAN intelligence may be enabled by further enhancement of data collection through use cases or examples. For example, principles or algorithms for RAN intelligence enabled by AI/ML and the associated functional framework (e.g., the AI functionality or the input/output of the component for AI enabled optimization) have been utilized or studied to identify the benefits of AI enabled RAN through possible use cases (e.g., beam management, energy saving, load balancing, mobility management, or coverage optimization, among other examples). In one example, as shown by the architecture 300, a functional framework for RAN intelligence may include multiple logical entities, such as a model training host 302, a model inference host 304, data sources 306, and an actor 308.

The model inference host 304 may be configured to run an AI/ML model based on inference data provided by the data sources 306, and the model inference host 304 may produce an output (e.g., a prediction) with the inference data input to the actor 308. The actor 308 may be an element or an entity of a core network or a RAN. For example, the actor 308 may be a UE, a network node, base station (e.g., a gNB), a CU, a DU, or an RU, among other examples. In addition, the actor 308 may also depend on the type of tasks performed by the model inference host 304, type of inference data provided to the model inference host 304, or type of output produced by the model inference host 304. For example, if the output from the model inference host 304 is associated with beam management, then the actor 308 may be a UE, a DU or an RU. In other examples, if the output from the model inference host 304 is associated with Tx/Rx scheduling, then the actor 308 may be a CU or a DU.

After the actor 308 receives an output from the model inference host 304, the actor 308 may determine whether to act based on the output. For example, if the actor 308 is a DU or an RU and the output from the model inference host 304 is associated with beam management, the actor 308 may determine whether to change/modify a Tx/Rx beam based on the output. If the actor 308 determines to act based on the output, the actor 308 may indicate the action to at least one subject of action 310. For example, if the actor 308 determines to change/modify a Tx/Rx beam for a communication between the actor 308 and the subject of action 310 (e.g., a UE 120), then the actor 308 may transmit a beam (re-)configuration or a beam switching indication to the subject of action 310. The actor 308 may modify its Tx/Rx beam based on the beam (re-)configuration, such as switching to a new Tx/Rx beam or applying different parameters for a Tx/Rx beam, among other examples. As another example, the actor 308 may be a UE and the output from the model inference host 304 may be associated with beam management. For example, the output may be one or more predicted measurement values for one or more beams. The actor 308 (e.g., a UE) may determine that a measurement report (e.g., a Layer 1 (L1) RSRP report) is to be transmitted to a network node 110.

The data sources 306 may also be configured for collecting data that is used as training data for training an ML model or as inference data for feeding an ML model inference operation. For example, the data sources 306 may collect data from one or more core network or RAN entities, which may include the subject of action 310, and provide the collected data to the model training host 302 for ML model training. For example, after a subject of action 310 (e.g., a UE 120) receives a beam configuration from the actor 308, the subject of action 310 may provide performance feedback associated with the beam configuration to the data sources 306, where the performance feedback may be used by the model training host 302 for monitoring or evaluating the ML model performance, such as whether the output (e.g., prediction) provided to the actor 308 is accurate. In some examples, if the output provided by the actor 308 is inaccurate (or the accuracy is below an accuracy threshold), then the model training host 302 may determine to modify or retrain the ML model used by the model inference host, such as via an ML model deployment/update.

In some aspects, a UE (e.g., UE 120) may use AI/ML to set one or more parameters for sidelink communication when the UE is in an out-of-coverage scenario. For example, in some aspects, the UE may use AI/ML to set one or more parameters associated with sidelink multi-RAT co-channel coexistence. Alternatively or in addition, the UE may use AI/ML to set one or more sidelink synchronization reference offsets. By using AI/ML to set one or more parameters for sidelink communications in out-of-coverage scenarios, the UE may experience better sidelink communication performance including decreased delay, reduced interference, or a combination thereof, among other examples.

In some aspects, a UE may be configured (statically or dynamically) with flexible thresholds, variables, parameters, or a combination thereof, among other examples, for coexistence between a first RAT and a second RAT, among others. For example, for out-of-coverage scenarios involving sidelink multi-RAT co-channel coexistence, the UE may be configured to perform mode 2 sidelink resource selection using an AI/ML model. In some aspects, the sidelink resource selection may be based, at least in part, on statically or dynamically configured parameters. In some aspects, the AI/ML model may account for one or more key performance indicators (KPIs) associated with each RAT. By considering the KPIs of each RAT, the AI/ML model may evaluate how different parameters for the resource selection may affect each RAT. For example, the AI/ML model may use KPIs to attempt to avoid resources where collisions are more likely to occur. Moreover, the KPIs may help the AI/ML model avoid aggressive channel access by one RAT and decrease channel access by another RAT.

Examples of flexible parameters may include a sidelink time resource parameter (e.g., sl-TimeResource), one or more physical sidelink shared channel (PSSCH) RSRP threshold ranges (e.g., sl-NRPSSCH-EUTRA-ThresRSRP-List-rxx), one or more physical sidelink feedback channel (PSFCH) RSRP threshold ranges (e.g., sl-NRPSFCH-EUTRA-ThresRSRP-List-rxx), or a combination thereof, among other examples.

For example, the sidelink time resource parameter may indicate an adaptable bitmap of a resource pool, which may be defined by repeating a bitmap with a periodicity during a system frame number (SFN) or discovery frame number (DFN) cycle. The resources indicated as available for the RAT may be set by the AI/ML model to increase or decrease the resources allocated for the RAT on the shared channel.

The sidelink PSSCH RSRP threshold ranges may indicate a list of ranges (e.g., a list of 64 ranges) of thresholds, and the range of thresholds may be selected in accordance with a priority in decoded or transmitted sidelink control information (SCI). In some aspects, the thresholds may be represented as a range from which the UE may select an initial threshold in accordance with an AI/ML model during a resource exclusion procedure. In some aspects, a sidelink resource may be excluded if it is indicated or reserved by a decoded SCI and the PSSCH RSRP in the associated data resource does not satisfy (e.g., exceeds) the threshold.

The sidelink PSFCH RSRP threshold ranges may indicate a list of ranges (e.g., a list of 64 ranges) of thresholds from which a range of thresholds may be selected in accordance with a priority in the decoded or transmitted SCI. In some aspects, the thresholds may be represented as a range from which the UE may select one threshold in accordance with the AI/ML model during a resource exclusion procedure. In some aspects, a sidelink resource may be excluded if a corresponding PSFCH transmission occasion overlaps with resources indicated or reserved by the decoded SCI in the time domain and the PSFCH RSRP in the associated data resource does not satisfy (e.g., exceeds) the threshold.

In some aspects, a UE with AI/ML capabilities and configured for multi-RAT co-channel coexistence may collect data to be used by the AI/ML model. The data may include data from collocated sensors or data from other UEs, among other examples. The data that may be collected by collocated sensors may include scene information, information about road or weather conditions, information about vehicle drivers or others, information from a vehicle sensor, or a combination thereof, among other examples. In some aspects, the scene information may include information that can be used to identify a potential environment setting (e.g., urban, rural, or highway, among other examples), expected link quality (e.g., line of sight or non-line of sight), or a presence of other sidelink UEs, (e.g., due to being in a crowded area with or in a sparsely populated area), among other examples. The information about road and weather conditions may include information about construction zones, rain, fog, snow, slippery roads, emergency vehicles, or temporary or permanent signs, among other examples. The information about vehicle drivers or others may include information about stranded vehicle occupants or drivers exhibiting dangerous, erratic, or unpredictable driving behavior.

In some aspects, the AI/ML model may consider data collected by other UEs. For example, for PSSCH and PSFCH collision avoidance, the AI/ML model may determine, from data collected by multiple UEs, a median RSRP threshold at which a resource exclusion process converges for a given priority level. Alternatively or in addition, the information from the other UEs may include a time division duplexing (TDD) bitmap used to schedule coexisting RATs on different time domain resources. The AI/ML model may consider the TDD bitmap when determining one or more parameters for sidelink multi-RAT co-channel coexistence. In some aspects, the data collected by one or more other UEs may include an indication of one or more resources where collisions with a different RAT are more likely. In some aspects, the one or more resources where collisions with a different RAT are more likely may be indicated by a probability value. In some aspects, the indication of the one or more resources where collisions with a different RAT are more likely may correspond to historical information associated with persistent collisions between different RATs.

In accordance with the information collected or received, the AI/ML model may assign a priority to different RATs. The co-channel coexistence parameters may be selected in accordance with the priority or a range of values (e.g., the sidelink PSSCH RSRP threshold range or the PSFCH RSRP threshold range, among other examples).

In some aspects, a network node may collect, directly or via a report transmitted from one or more sidelink UEs, performance KPIs to evaluate performance of the AI/ML model. Examples of KPIs the sidelink UEs may be configured to report to the network node may include one or more quality of service metrics for one or more traffic flows, channel occupancy and channel busy ratios, link reliability metrics for each RAT-based communication, or a combination thereof, among other examples. The quality of service metrics may include a throughput metric or a delay metric, among other examples, for each coexisting RAT. The channel occupancy and channel busy ratios may include total channel occupancy and channel busy ratios for all coexisting RATs, individual channel occupancy and channel busy ratio for each coexisting RAT, or a combination thereof, among other examples. In some aspects, the channel occupancy and channel busy ratios may allow the network node to evaluate performance of the AI/ML model and to maximize the total channel occupancy while assigning appropriate resources to each RAT.

In some aspects, the UE may be configured to use the AI/ML model for sidelink synchronization reference selection when, for example, the UE is in an out-of-coverage scenario. In some aspects, the UE may switch from a first synchronization reference to a second synchronization reference in accordance with the second synchronization reference having a higher priority than the first synchronization reference. In some aspects, such as when the first synchronization reference and the second synchronization reference have the same priority, the UE may be configured to select the second synchronization reference as a result of the second synchronization reference having a higher RSRP. In some aspects, the UE may apply a synchronization reference offset to avoid continuously switching between two or more synchronization references that have the same priority, similar RSRPs (e.g., RSRPs having a difference that is less than a value of the offset), or a combination thereof, among other examples. In some aspects, the synchronization references may be identified by a sidelink synchronization signal (SLSS) identifier and an associated master information block (MIB) transmitted by one or more UEs.

In some aspects, the AI/ML model may select a parameter value for the synchronization reference offset from a set of candidate values to, for example, avoid or minimize continuously switching between two or more synchronization references or minimize delay in selecting synchronization references, among other examples. In some aspects, the UE may be configured, by a network node or via firmware, with the set of candidate values or a range of candidate values for the synchronization reference offset, a subset of parameter values from the candidate values, or a range within the range of candidate values, among other examples. Using the AI/ML model, the UE may be configured to select the parameter value for the synchronization reference offset from the configured subset or range of candidate values. In some aspects, the range of candidate values may include a maximum candidate value and a minimum candidate value, and the UE may be configured to select, via the AI/ML model any value between the maximum candidate value and the minimum candidate value as the parameter value. In some aspects, the subset of candidate values may include two or more candidate values for the synchronization reference offset, and the UE may be configured to select, via the AI/ML model, one of the two or more candidate values as the parameter value for the synchronization reference offset. Alternatively, in some aspects, the UE may be configured, by a network node or via firmware, to select the parameter value from the set of candidate values for the parameter value without a configuration for the subset or range of candidate values discussed above.

Alternatively, in some aspects, the UE may be configured, by a network node or via firmware, with a set of candidate values or a range of candidate values for the parameter value as discussed above, and the UE may be further configured, via a network node or firmware, with a default parameter value from among the candidate values (e.g., from the set of candidate values or within the range of candidate values). The UE may also be configured with a parameter delta, and the UE may be configured to select, using the AI/ML model, the parameter value in accordance with a range defined by the default parameter value and the parameter delta. In some aspects, the range may include a maximum parameter value, which may be defined by the default parameter value plus the parameter delta, and a minimum parameter value, which many be defined by the default parameter value minus the parameter delta.

In some aspects, the candidate parameter values for the synchronization reference offset may be specified as a range between a maximum value and a minimum value. In some aspects, the UE may be configured, by a network node or via firmware, with a step value, and the UE may be configured to select, using the AI/ML model, the synchronization reference offset in accordance with the minimum value, the maximum value, and the step value. For example, the UE may be configured to determine, using the AI/ML model, a set of candidate parameter values that includes the minimum value, the maximum value, and one or more candidate parameter values between the minimum value and the maximum value. Each of the one or more candidate parameter values may be separated from one another, from the minimum value, or from the maximum value by the step value. For example, with a configured minimum value of 0 dB and maximum value of 120 dB, the set of candidate values may be separated by a configured step value of 3 dB. Accordingly, the candidate parameter values may be 0 dB, 3 dB, 6 dB, 9 dB, and 12 dB. Alternatively, the set of candidate values may be separated by a different quantity. For example, the set of candidate values may be separated by 1 dB or 2 dB, among other examples. In some aspects, the UE may be further configured with a candidate value of Inf dB, which may represent an unbound maximum candidate value. In some aspects, configuring the UE with the same maximum value and minimum value may prevent the UE from switching between synchronization references. Accordingly, when the UE is configured with the same maximum value and minimum value for the range of candidate parameter values, the UE may apply a default maximum value and a default minimum value in accordance with a configuration by a network node or via firmware. In some aspects, the UE may be configured to select, using the AI/ML model, the parameter value from among a set of candidate values.

In some aspects, the AI/ML model of the UE may be trained offline and loaded to the UE. Alternatively or in addition, the AI/ML model may be trained by the UE, and the UE may be configured, by a network node or via firmware, with a model structure (e.g., input parameters, output parameters, number of layers or neurons, or a combination thereof, among other examples) for training the AI/ML model to select the synchronization reference offset. In some aspects, the network may train and store the AI/ML model for selecting the synchronization reference offset, and the AI/ML model may be transferred to the UE by a network node so the UE can use the model to select the synchronization reference offset.

In some aspects, the AI/ML model may be configured to receive one or more inputs and provide one or more outputs associated with the synchronization reference offset. For example, in some aspects, the AI/ML model may receive, as input, one or more previous sidelink RSRP measurements for a first synchronization reference (e.g., a current synchronization reference), one or more consecutive sidelink RSRP measurements for a second synchronization reference (e.g., a newly available candidate synchronization reference), a range of candidate parameter values, a set of candidate parameter values, or a combination thereof, among other examples. In some aspects, the AI/ML model may be configured to output the parameter value for the synchronization reference offset, an indication or recommendation associated with switching to the second synchronization reference or continuing to use the first synchronization reference, or a combination thereof, among other examples. In some aspects, the indication or recommendation associated with switching to the second synchronization reference or continuing to use the first synchronization reference may be a Boolean value.

In some aspects, the UE may be configured to evaluate performance of the AI/ML model via one or more KPIs. In some aspects, the UE may be configured to update the AI/ML model in accordance with the one or more KPIs. For example, in some aspects, the UE may be configured to monitor a parameter associated with the ping-pong effect, which, as discussed above, occurs when the UE continuously switches between multiple synchronization sources. The UE may monitor the occurrences of the ping-pong effect relative to a time window and update the AI/ML model with one or more parameters to reduce the likelihood of the ping-pong effect occurring. In some aspects, another KPI may include one or more parameters related to the number of occurrences of synchronization reference reselection events (e.g., a quantity of synchronization reference reselection events occurring within a time window). The UE may update the AI/ML model to reduce or minimize the quantity of synchronization reference reselection events. Alternatively or additionally, another KPI may include a number or ratio associated with synchronization failures with a current synchronization reference, which may indicate that the UE is staying with a synchronization reference too long as, for example, a result of the synchronization reference offset being too high. The synchronization failure may occur when the sidelink RSRP of the current synchronization reference fails to satisfy a threshold (e.g., is below a threshold). When the UE returns to coverage, the UE may be configured to transmit, to a network node, a report with one or more KPI values. In some aspects, the UE may be configured to report the synchronization reference offset used while out of coverage. For network-side AI/ML models, the network node may use the reports received from the UE to update the AI/ML model.

As indicated above, FIG. 3 is provided as an example. Other examples may differ from what is described with regard to FIG. 3.

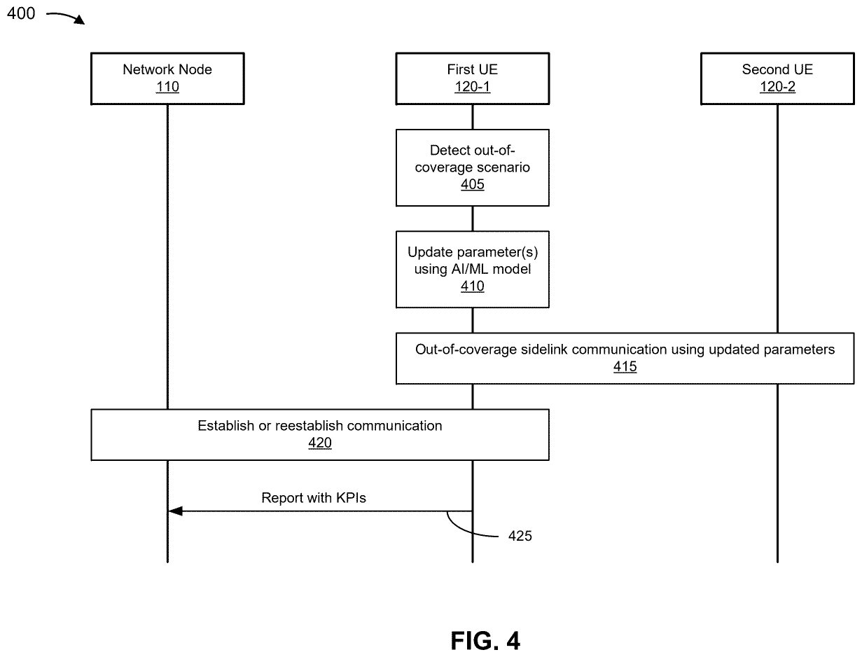

FIG. 4 is a diagram illustrating an example 400 associated with using an AI/ML model to update one or more sidelink parameters in an out-of-coverage scenario. As shown in FIG. 4, a network node 110 and a first UE 120-1 may communicate with one another via uplink and downlink communications, and the first UE 120-1 and a second UE 120-2 may communicate with one another via sidelink. In some aspects, the first UE 120-1 and the second UE 120-2 may communicate via a wireless channel shared by multiple RATs.

As shown by reference number 405, the first UE 120-1 may detect an out-of-coverage scenario. In some aspects, the first UE 120-1 may detect the out-of-coverage scenario as a result of the first UE 120-1 losing and being unable to reestablish communication with the network node 110. In some aspects, the first UE 120-1 may detect the out-of-coverage scenario as a result of the first UE 120-1 being unable to synchronize with the network node 110.

As shown by reference number 410, the first UE 120-1 may update one or more parameters for sidelink communication. In some aspects, the first UE 120-1 may be configured to update one or more parameters associated with sidelink multi-RAT co-channel coexistence, one or more parameters associated with sidelink synchronization reference offset selection, or a combination thereof, among other examples. In some aspects, as discussed above, the first UE 120-1 may update the one or more parameters for the multi-RAT co-channel coexistence, the synchronization reference offset, or both, among other examples, in accordance with an output of an AI/ML model.

As shown by reference number 415, the first UE 120-1 and the second UE 120-2 may engage in sidelink communication. For example, the first UE 120-1 may transmit, and the second UE 120-2 may receive, sidelink communications. Additionally, the second UE 120-2 may transmit, and the first UE 120-1 may receive, sidelink communications. In some aspects, the first UE 120-1, the second UE 120-2, or both, may monitor one or more KPIs corresponding to the sidelink communications. In some aspects, as discussed above, the first UE 120-1 may monitor one or more KPIs associated with performance of the AI/ML model used to update the one or more parameters used for the sidelink communication between the first UE 120-1 and the second UE 120-2.

As shown by reference number 420, the first UE 120-1 and the network node 110 may establish or reestablish communication. Communication between the first UE 120-1 and the network node 110 may be reestablished as a result of, for example, the first UE 120-1 moving to a location within a coverage area of the network node 110. With communication between the first UE 120-1 and the network node 110 established or reestablished, the first UE 120-1 may communicate with one another.

As shown by reference number 425, the first UE 120-1 may transmit, and the network node 110 may receive, a report with one or more KPIs. In some aspects, the report may include one or more KPIs associated with the sidelink communication between the first UE 120-1 and the second UE 120-2, the performance of the AI/ML model, or a combination thereof, among other examples.

As indicated above, FIG. 4 is provided as an example. Other examples may differ from what is described with respect to FIG. 4.

FIG. 5 is a diagram illustrating an example process 500 performed, for example, at a UE (e.g., a first UE) or an apparatus of a UE. Example process 500 is an example where the apparatus or the UE (e.g., UE 120) performs operations associated with sidelink operation in accordance with one or more parameters set via an AI/ML model.

As shown in FIG. 5, in some aspects, process 500 may include selecting, in accordance with an AI/ML model, a sidelink parameter value for sidelink communication with a second UE using a first RAT over a wireless channel shared by the first RAT and one or more second RATs. The sidelink parameter value may be selected from a range of candidate parameter values (block 510). For example, the UE (e.g., using communication manager 706, depicted in FIG. 7) may select, in accordance with an AI/ML model, a sidelink parameter value for sidelink communication with a second UE using a first RAT over a wireless channel shared by the first RAT and one or more second RATs, as described above. In some aspects, the sidelink parameter value may be selected from a range of candidate parameter values.

As further shown in FIG. 5, in some aspects, process 500 may include updating the range of candidate parameter values in accordance with one or more measurements (block 520). For example, the UE (e.g., using communication manager 706, depicted in FIG. 7) may update the range of candidate parameter values in accordance with one or more measurements, as described above.

As further shown in FIG. 5, in some aspects, process 500 may include transmitting, in accordance with the selected sidelink parameter value, a communication over the wireless channel shared by the first RAT and the one or more second RATs (block 530). For example, the UE (e.g., using transmission component 702, depicted in FIG. 7) may transmit the communication over the wireless channel shared by the first RAT and the one or more second RATs in accordance with the selected sidelink parameter value.

Process 500 may include additional aspects, such as any single aspect or any combination of aspects described below or in connection with one or more other processes described elsewhere herein.

In a first aspect, the sidelink parameter value may include at least one of one or more resources for sidelink communications on the first RAT, one or more resources for sidelink communications on the one or more second RATs, one or more RSRP thresholds for dynamic cochannel coexistence-based resource selection on resources for the first RAT, a synchronization reference value, or a synchronization reference difference hysteresis value.

In a second aspect, alone or in combination with the first aspect, each of the one or more resources for sidelink communication on the first RAT may be different from each of the one or more resources for sidelink communication on the one or more second RATs.

In a third aspect, alone or in combination with one or more of the first and second aspects, at least one of the one or more resources for sidelink communication on the first RAT at least partially overlaps at least one of the one or more resources for sidelink communications on the one or more second RATs.

In a fourth aspect, alone or in combination with one or more of the first through third aspects, the one or more measurements include an RSRP associated with the second UE.

In a fifth aspect, alone or in combination with one or more of the first through fourth aspects, the sidelink parameter value may be associated with V2X communication.

In a sixth aspect, alone or in combination with one or more of the first through fifth aspects, process 500 may include measuring an RSRP of the second UE.

In a seventh aspect, alone or in combination with one or more of the first through sixth aspects, the sidelink parameter value may be associated with mode 2 sidelink resource selection for multi-RAT co-channel coexistence.

In an eighth aspect, alone or in combination with one or more of the first through seventh aspects, the sidelink parameter value may be associated with one or more key performance indicators.

In a ninth aspect, alone or in combination with one or more of the first through eighth aspects, the sidelink parameter value may be associated with one or more of a sidelink time resource or an RSRP threshold.

In a tenth aspect, alone or in combination with one or more of the first through ninth aspects, the range of candidate parameter values may include a first range of RSRP thresholds that exclude one or more resources for a data transmission, and a second range of RSRP thresholds that exclude resources for a feedback reception associated with the data transmission.

In an eleventh aspect, alone or in combination with one or more of the first through tenth aspects, process 500 may include receiving sensor data. The sensor data may be associated with one or more of scene information, an expected link quality, or a presence of one or more other sidelink UEs.

In a twelfth aspect, alone or in combination with one or more of the first through eleventh aspects, process 500 may include receiving sensor data from the second UE.

In a thirteenth aspect, alone or in combination with one or more of the first through twelfth aspects, the sensor data may include one or more of a median RSRP threshold, a time domain duplexing bitmap, one or more resources associated with a RAT collision probability, or one or more resources associated with persistent RAT collisions.

In a fourteenth aspect, alone or in combination with one or more of the first through thirteenth aspects, process 500 may include transmitting, to a network node, one or more KPIs.

The one or more KPIs include one or more of a quality of service, a channel occupancy ratio, a channel busy ratio, or a link reliability metric.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, at a UE (e.g., a first UE) or an apparatus of a UE. Example process 600 is an example where the apparatus or the UE (e.g., UE 120) performs operations associated with sidelink operation in accordance with one or more parameters set via an AI/ML model.

As shown in FIG. 6, in some aspects, process 600 may include selecting, in accordance with an AI/ML model, a sidelink parameter value for sidelink communication with a second UE without a synchronization source. The sidelink parameter value may be selected from a range of candidate parameter values and may be associated with a synchronization reference offset (block 610). For example, the UE (e.g., using communication manager 706, depicted in FIG. 7) may select, in accordance with an AI/ML model, a sidelink parameter value for sidelink communication with a second UE without a synchronization source. In some aspects, the sidelink parameter value may be selected from a range of candidate parameter values and may be associated with a synchronization reference offset.

As further shown in FIG. 6, in some aspects, process 600 may include updating the range of candidate parameter values in accordance with one or more measurements (block 620). For example, the UE (e.g., using communication manager 706, depicted in FIG. 7) may update the range of candidate parameter values in accordance with one or more measurements, as described above.

Process 600 may include additional aspects, such as any single aspect or any combination of aspects described below or in connection with one or more other processes described elsewhere herein.

In a first aspect, process 600 may include determining the synchronization reference offset in accordance with the AI/ML model.

In a second aspect, alone or in combination with the first aspect, process 600 may include receiving a configuration or pre-configuration including one or more candidate parameter values in the range of candidate parameter values.

In a third aspect, alone or in combination with one or more of the first and second aspects, selecting the sidelink parameter value may include selecting the sidelink parameter value in accordance with the configuration or pre-configuration.

In a fourth aspect, alone or in combination with one or more of the first through third aspects, the configuration or pre-configuration may include one or more of a default parameter value and a parameter delta. Selecting the sidelink parameter value may include selecting the sidelink parameter value in accordance with the default parameter value and the parameter delta.

In a fifth aspect, alone or in combination with one or more of the first through fourth aspects, the configuration or pre-configuration specifies the range of candidate parameter values as a minimum parameter value and a maximum parameter value.

In a sixth aspect, alone or in combination with one or more of the first through fifth aspects, the configuration or pre-configuration specifies a step value associated with the range of candidate parameter values.

In a seventh aspect, alone or in combination with one or more of the first through sixth aspects, the configuration or pre-configuration may include one or more KPIs for training the AI/ML model.

In an eighth aspect, alone or in combination with one or more of the first through seventh aspects, the one or more KPIs for training the AI/ML model include one or more of a quantity of synchronization reference reselection ping-pongs, a quantity of synchronization reference reselection events, or a quantity or ratio associated with synchronization failures.

In a ninth aspect, alone or in combination with one or more of the first through eighth aspects, process 600 may include transmitting the one or more KPIs for training the AI/ML model to a network node.

In a tenth aspect, alone or in combination with one or more of the first through ninth aspects, process 600 may include transmitting the sidelink parameter value to a network node.

In an eleventh aspect, alone or in combination with one or more of the first through tenth aspects, process 600 may include transmitting, to a network node, one or more of a reselection event report, a sidelink RSRP (S-RSRP) for a current synchronization reference offset, or an S-RSRP for a reselected synchronization reference offset.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication. The apparatus 700 may be a UE (e.g., a first UE), or a UE may include the apparatus 700. In some aspects, the apparatus 700 may include a reception component 702, a transmission component 704, or a communication manager 706, which may be in communication with one another (for example, via one or more buses or one or more other components). In some aspects, the communication manager 706 is the communication manager 150 described in connection with FIG. 1. As shown, the apparatus 700 may communicate with another apparatus 708, such as a UE or a network node (such as a CU, a DU, an RU, or a base station), using the reception component 702 and the transmission component 704. The communication manager 706 may be included in, or implemented via, a processing system (for example, the processing system 140 described in connection with FIG. 1) of the UE.

In some aspects, the apparatus 700 may be configured to perform one or more operations described herein in connection with FIGS. 3-4. Additionally, or alternatively, the apparatus 700 may be configured to perform one or more processes described herein, such as process 500 of FIG. 5, process 600 of FIG. 6, or a combination thereof. In some aspects, the apparatus 700 or one or more components shown in FIG. 7 may include one or more components of the UE described in connection with FIG. 1. Additionally, or alternatively, one or more components shown in FIG. 7 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications, and may provide the processed signals to the one or more other components of the apparatus 700. In some aspects, the reception component 702 may include one or more components of the UE described above in connection with FIG. 1, such as a radio, one or more RF chains, one or more transceivers, or one or more modems, each of which may in turn be coupled with one or more antennas of the UE.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications, and may transmit the processed signals to the apparatus 708. In some aspects, the transmission component 704 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 704 may be co-located with the reception component 702.

The communication manager 706 may support operations of the reception component 702 or the transmission component 704. For example, the communication manager 706 may receive information associated with configuring reception of communications by the reception component 702 or transmission of communications by the transmission component 704. Additionally, or alternatively, the communication manager 706 may generate or provide control information to the reception component 702 or the transmission component 704 to control reception or transmission of communications.

In some aspects, the communication manager 706 may select, in accordance with an AI/ML model, a sidelink parameter value for sidelink communication with a second UE using a first RAT over a wireless channel shared by the first RAT and one or more second RATs. The sidelink parameter value may be selected from a range of candidate parameter values. The communication manager 706 may update the range of candidate parameter values in accordance with one or more measurements. The communication manager 706 may measure an RSRP of the second UE. The reception component 702 may receive sensor data. The sensor data may be associated with one or more of scene information, an expected link quality, or a presence of one or more other sidelink UEs. The reception component 702 may receive sensor data from the second UE. The transmission component 704 may transmit, to a network node, one or more KPIs. The one or more KPIs include one or more of a quality of service, a channel occupancy ratio, a channel busy ratio, or a link reliability metric.

In some aspects, the communication manager 706 may select, in accordance with an AI/ML model, a sidelink parameter value for sidelink communication with a second UE without a synchronization source. The sidelink parameter value may be selected from a range of candidate parameter values and may be associated with a synchronization reference offset. The communication manager 706 may update the range of candidate parameter values in accordance with one or more measurements. The communication manager 706 may determine the synchronization reference offset in accordance with the AI/ML model. The reception component 702 may receive a configuration or pre-configuration including one or more candidate parameter values in the range of candidate parameter values. The transmission component 704 may transmit the one or more KPIs for training the AI/ML model to a network node. The transmission component 704 may transmit the sidelink parameter value to a network node. The transmission component 704 may transmit, to a network node, one or more of a reselection event report, a sidelink RSRP for a current synchronization reference offset, or an S-RSRP for a reselected synchronization reference offset.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

The following provides an overview of some Aspects of the present disclosure:

Aspect 1: A method of wireless communication performed by a first UE, comprising: selecting, in accordance with an AI/ML model, a sidelink parameter value for sidelink communication with a second UE using a first RAT over a wireless channel shared by the first RAT and one or more second RATs, wherein the sidelink parameter value is selected from a range of candidate parameter values; updating the range of candidate parameter values in accordance with one or more measurements; and transmitting, in accordance with the selected sidelink parameter value, a communication over the wireless channel shared by the first RAT and the one or more second RATs.

Aspect 2: The method of Aspect 1, wherein the sidelink parameter value includes at least one of one or more resources for sidelink communications on the first RAT, one or more resources for sidelink communications on the one or more second RATs, one or more RSRP thresholds for dynamic cochannel coexistence-based resource selection on resources for the first RAT, a synchronization reference value, or a synchronization reference difference hysteresis value.

Aspect 3: The method of Aspect 2, wherein each of the one or more resources for sidelink communication on the first RAT is different from each of the one or more resources for sidelink communication on the one or more second RATs.

Aspect 4: The method of Aspect 2, wherein at least one of the one or more resources for sidelink communication on the first RAT at least partially overlaps at least one of the one or more resources for sidelink communications on the one or more second RATs.

Aspect 5: The method of any of Aspects 1-4, wherein the one or more measurements include an RSRP associated with the second UE.

Aspect 6: The method of any of Aspects 1-5, wherein the sidelink parameter value is associated with V2X communication.

Aspect 7: The method of any of Aspects 1-6, further comprising measuring an RSRP of the second UE.

Aspect 8: The method of any of Aspects 1-7, wherein the sidelink parameter value is associated with mode 2 sidelink resource selection for multi-RAT co-channel coexistence.

Aspect 9: The method of any of Aspects 1-8, wherein the sidelink parameter value is associated with one or more key performance indicators.

Aspect 10: The method of any of Aspects 1-9, wherein the sidelink parameter value is associated with one or more of a sidelink time resource or an RSRP threshold.

Aspect 11: The method of any of Aspects 1-10, wherein the range of candidate parameter values includes a first range of RSRP thresholds that exclude one or more resources for a data transmission, and a second range of RSRP thresholds that exclude resources for a feedback reception with the data transmission.

Aspect 12: The method of any of Aspects 1-11, further comprising receiving sensor data, wherein the sensor data is associated with one or more of scene information, an expected link quality, or a presence of one or more other sidelink UEs.

Aspect 13: The method of any of Aspects 1-12, further comprising receiving sensor data from the second UE.

Aspect 14: The method of Aspect 13, wherein the sensor data includes one or more of a median RSRP threshold, a time domain duplexing bitmap, one or more resources associated with a RAT collision probability, or one or more resources associated with persistent RAT collisions.

Aspect 15: The method of any of Aspects 1-14, further comprising transmitting, to a network node, one or more KPIs, wherein the one or more KPIs include one or more of a quality of service, a channel occupancy ratio, a channel busy ratio, or a link reliability metric.

Aspect 16: A method of wireless communication performed by a first UE, comprising: selecting, in accordance with an AI/ML model, a sidelink parameter value for sidelink communication with a second UE without a synchronization source, wherein the sidelink parameter value is selected from a range of candidate parameter values and is associated with a synchronization reference offset; and updating the range of candidate parameter values in accordance with one or more measurements.

Aspect 17: The method of Aspect 16, further comprising determining the synchronization reference offset in accordance with the AI/ML model.

Aspect 18: The method of any of Aspects 16-17, further comprising receiving a configuration or pre-configuration including one or more candidate parameter values in the range of candidate parameter values.

Aspect 19: The method of Aspect 18, wherein selecting the sidelink parameter value includes selecting the sidelink parameter value in accordance with the configuration or pre-configuration.

Aspect 20: The method of Aspect 18, wherein the configuration or pre-configuration includes one or more of a default parameter value and a parameter delta, wherein selecting the sidelink parameter value includes selecting the sidelink parameter value in accordance with the default parameter value and the parameter delta.

Aspect 21: The method of Aspect 18, wherein the configuration or pre-configuration specifies the range of candidate parameter values as a minimum parameter value and a maximum parameter value.

Aspect 22: The method of Aspect 18, wherein the configuration or pre-configuration specifies a step value associated with the range of candidate parameter values.

Aspect 23: The method of Aspect 18, wherein the configuration or pre-configuration includes one or more KPIs for training the AI/ML model.

Aspect 24: The method of Aspect 23, wherein the one or more KPIs for training the AI/ML model include one or more of a quantity of synchronization reference reselection ping-pongs, a quantity of synchronization reference reselection events, or a quantity or ratio associated with synchronization failures.

Aspect 25: The method of Aspect 23, further comprising transmitting the one or more KPIs for training the AI/ML model to a network node.

Aspect 26: The method of any of Aspects 16-25, further comprising transmitting the sidelink parameter value to a network node.

Aspect 27: The method of any of Aspects 16-26, further comprising transmitting, to a network node, one or more of a reselection event report, a sidelink RSRP for a current synchronization reference offset, or an S-RSRP for a reselected synchronization reference offset.

Aspect 28: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-27.

Aspect 29: An apparatus for wireless communication at a device, the apparatus comprising one or more memories and one or more processors coupled to the one or more memories, the one or more processors configured to cause the device to perform the method of one or more of Aspects 1-27.

Aspect 30: An apparatus for wireless communication, the apparatus comprising at least one means for performing the method of one or more of Aspects 1-27.

Aspect 31: A non-transitory computer-readable medium storing code for wireless communication, the code comprising instructions executable by one or more processors to perform the method of one or more of Aspects 1-27.

Aspect 32: A non-transitory computer-readable medium storing a set of instructions for wireless communication, the set of instructions comprising one or more instructions that, when executed by one or more processors of a device, cause the device to perform the method of one or more of Aspects 1-27.

Aspect 33: A device for wireless communication, the device comprising a processing system that includes one or more processors and one or more memories coupled with the one or more processors, the processing system configured to cause the device to perform the method of one or more of Aspects 1-27.

Aspect 34: An apparatus for wireless communication at a device, the apparatus comprising one or more memories and one or more processors coupled to the one or more memories, the one or more processors individually or collectively configured to cause the device to perform the method of one or more of Aspects 1-27.

Aspect 35: A device comprising a processing system that includes one or more processors and one or more code-storing memories coupled with the one or more processors, the processing system configured to cause the device to perform the method of one or more of Aspects 1-27.

Aspect 36: A device comprising a processing system that includes processor circuitry and code-storing memory circuitry, the processing system configured to cause the device to perform the method of one or more of Aspects 1-27.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A first user equipment (UE), comprising:
a processing system that includes one or more processors and one or more code-storing memories coupled with the one or more processors, the processing system configured to cause the UE to:
select, in accordance with an artificial intelligence/machine learning (AI/ML) model, a sidelink parameter value for sidelink communication with a second UE using a first radio access technology (RAT) over a wireless channel shared by the first RAT and one or more second RATs,
wherein the sidelink parameter value is selected from a range of candidate parameter values;
update the range of candidate parameter values in accordance with one or more measurements; and
transmit, in accordance with the selected sidelink parameter value, a communication over the wireless channel shared by the first RAT and the one or more second RATs.

2. The UE of claim 1, wherein the sidelink parameter value includes at least one of one or more resources for sidelink communications on the first RAT, one or more resources for sidelink communications on the one or more second RATs, one or more reference signal received power (RSRP) thresholds for dynamic cochannel coexistence-based resource selection on resources for the first RAT, a synchronization reference value, or a synchronization reference difference hysteresis value.

3. The UE of claim 2, wherein each of the one or more resources for sidelink communication on the first RAT is different from each of the one or more resources for sidelink communication on the one or more second RATs.

4. The UE of claim 2, wherein at least one of the one or more resources for sidelink communication on the first RAT at least partially overlaps at least one of the one or more resources for sidelink communications on the one or more second RATs.

5. The UE of claim 1, wherein the one or more measurements include a reference signal received power associated with the second UE.

6. The UE of claim 1, wherein the sidelink parameter value is associated with one or more of:
mode 2 sidelink resource selection for multi-RAT co-channel coexistence;
one or more key performance indicators; or
one or more of a sidelink time resource or a reference signal received power threshold.

7. The UE of claim 1, wherein the range of candidate parameter values includes:
a first range of reference signal received power (RSRP thresholds that exclude one or more resources for a data transmission; and
a second range of RSRP thresholds that exclude resources for a feedback reception associated with the data transmission.

8. The UE of claim 1, wherein the processing system is configured to cause the UE to receive sensor data, wherein the sensor data is associated with one or more of scene information, an expected link quality, or a presence of one or more other sidelink UEs.

9. The UE of claim 1, wherein the processing system is configured to cause the UE to receive sensor data from the second UE,
wherein the sensor data includes one or more of a median reference signal received power threshold, a time domain duplexing bitmap, one or more resources associated with a RAT collision probability, or one or more resources associated with persistent RAT collisions.

10. The UE of claim 1, wherein the processing system is configured to cause the UE to transmit, to a network node, one or more key performance indicators (KPIs), wherein the one or more KPIs include one or more of a quality of service, a channel occupancy ratio, a channel busy ratio, or a link reliability metric.

11. A UE, comprising:
a processing system that includes one or more processors and one or more code-storing memories coupled with the one or more processors, the processing system configured to cause the UE to:
select, in accordance with an artificial intelligence/machine learning (AI/ML) model, a sidelink parameter value for sidelink communication with a second UE without a synchronization source,
wherein the sidelink parameter value is selected from a range of candidate parameter values and is associated with a synchronization reference offset; and
update the range of candidate parameter values in accordance with one or more measurements.

12. The UE of claim 11, wherein the processing system is configured to cause the UE to determine the synchronization reference offset in accordance with the AI/ML model.

13. The UE of claim 11, wherein the processing system is configured to cause the UE to receive a configuration or pre-configuration including one or more candidate parameter values in the range of candidate parameter values.

14. The UE of claim 13, wherein the configuration or pre-configuration includes one or more of a default parameter value and a parameter delta,
wherein the processing system, to cause the UE to select the sidelink parameter value, is configured to cause the UE to select the sidelink parameter value in accordance with the default parameter value and the parameter delta.

15. The UE of claim 13, wherein the configuration or pre-configuration specifies the range of candidate parameter values as a minimum parameter value and a maximum parameter value.

16. The UE of claim 13, wherein the configuration or pre-configuration specifies a step value associated with the range of candidate parameter values.

17. The UE of claim 13, wherein the configuration or pre-configuration includes one or more key performance indicators (KPIs) for training the AI/ML model.

18. The UE of claim 17, wherein the one or more KPIs for training the AI/ML model include one or more of a quantity of synchronization reference reselection ping-pongs, a quantity of synchronization reference reselection events, or a quantity or ratio associated with synchronization failures.

19. The UE of claim 11, wherein the processing system is configured to cause the UE to transmit, to a network node, one or more of a reselection event report, a sidelink reference signal received power (S-RSRP) for a current synchronization reference offset, or an S-RSRP for a reselected synchronization reference offset.

20. A method of wireless communication performed by a first user equipment (UE), comprising:
selecting, in accordance with an artificial intelligence/machine learning (AI/ML) model, a sidelink parameter value for sidelink communication with a second UE using a first radio access technology (RAT) over a wireless channel shared by the first RAT and one or more second RATs,
wherein the sidelink parameter value is selected from a range of candidate parameter values;
updating the range of candidate parameter values in accordance with one or more measurements; and
transmitting, in accordance with the selected sidelink parameter value, a communication over the wireless channel shared by the first RAT and the one or more second RATs.
